(19) United States
(12) Patent Application Publication
(10) Pub. No.: US 2005/0117814 A1
(43) Pub. Date: Jun. 2, 2005

(54) Noise filtering in images

(75) Inventors: Abraham Karel Riemens, Eindhoven (NL); Robert Jan Schutten, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/505,496

(22) PCT Filed: Feb. 7, 2003
(86) PCT No.: PCT/IB03/00468

(30) Foreign Application Priority Data
Feb. 28, 2002 (EP) 02075804.1

(51) Int. Cl. G06K 9/40

(52) U.S. Cl. 382/275; 382/265

(57) ABSTRACT

A temporal recursive filter unit (100,200,300,400) for noise filtering of a series of input images resulting in a series of output images comprises: means (102) for determining a value of a weighing factor, on basis of a difference between a first value of a first pixel of an input image and a second value of a second pixel of a first output image; and an adding (104) unit for calculating a third value of a third pixel of a second output image by adding of a first product of the value of the weighing factor and the first value of the first pixel, to a second product of a complement of the value of the weighing factor and the second value of the second pixel. The value (508) of the weighing factor is higher below a predetermined threshold (506) than above the threshold (506).

The invention relates to a temporal recursive filter unit for noise filtering of a series of input images resulting in a series of output images, comprising:
means for determining a value of a weighing factor, on basis of a difference between a first value of a first pixel of an input image of the series of input images and a second value of a second pixel of a first output image of the series of output images; and
an adding unit for calculating a third value of a third pixel of a second output image of the series of output images by adding of a first product of the value of the weighing factor and the first value of the first pixel, to a second product of a complement of the value of the weighing factor and the second value of the second pixel.

The invention further relates to method of noise filtering of a series of input images resulting in a series of output images, comprising:
a weighing factor determination step of determining a value of a weighing factor, on basis of a difference between a first value of a first pixel of an input image of the series of input images and a second value of a second pixel of a first output image of the series of output images; and
an adding step of calculating a third value of a third pixel of a second output image of the series of output images by adding of a first product of the value of the weighing factor and the first value of the first pixel, to a second product of a complement of the value of the weighing factor and the second value of the second pixel.

The invention further relates to an image processing apparatus comprising:
receiving means for receiving a series of input images; and
such a temporal recursive filter unit for noise filtering of the series of input images resulting in a series of output images.

A unit of the kind described in the opening paragraph is known from U.S. Pat. No. 6,115,502. In that patent is described that a fresh input signal and a previously filtered signal are combined in the proportion k: (1−k), where k depends on a local amount of motion. In this manner, it is attempted to avoid smear obtained by averaging signals from mutually differing temporal instants in the presence of motion, while the noise filtering is fully active in the absence of motion. The variable k can be seen as a factor determining how much fresh input directly influence the filter output. The variable k is determined with a so-called motion detector. The variable is based on luminance differences between pixels of input images and output images. It is assumed that the luminance difference between input and output is a measure for the amount of motion. The value of variable k as function of luminance difference is monotonous: the higher the luminance differences between pixels the lower the value of variable k. Typically the value of k ranges from zero to one. A small difference is typically considered noise, and thus the k value will be close to zero, resulting in strong filtering. A large difference between input and output typically identifies motion in the scene and results in a higher value of k, thus preserving as much image detail as possible.

In a fixed point arithmetic implementation of a unit of the kind described in the opening paragraph, the internal calculations require a higher precision, i.e. word size than which is required to represent the input and output images. So, prior to the output of the unit, the accuracy of the signal has to be reduced. In a straightforward implementation the internal signal is rounded and the unused bits truncated. For example a 12 bits intermediate value is rounded to 8 bits. First the value 0.5 in fixed point 4 bits notation is added. Then the 4 least significant bits are removed by truncation. Such a filter unit, based on fixed point arithmetic, suffers from a known artifact, caused by the recursive nature of the filter unit. The value of an output pixel provided by the recursive filter unit will generally not reach the required value after a sudden change in the input signal. This artifact is known as “long term dirty window effect”. For example, when the input signal changes from a picture to black, a vague remainder image of the original input signal is left on the display.

It is an object of the invention to provide a filter unit of the kind described in the opening paragraph in which the above described artifact hardly occurs. The object of the invention is achieved in that the means for determining the value of the weighing factor is arranged to provide the value of the weighing factor, which is higher than a further value of the weighing factor if the difference between the first value and the second value is below a predetermined threshold, with the further value belonging to a further difference of further values of further pixels, with the further difference being above the predetermined threshold. Instead of applying a low value of the weighing factor in the case of a small difference between the pixels a relatively high value is applied. E.g. if the value of the weighing factor ranges from [0,1] then the value of the weighing factor is set to 0.5 if the difference between the pixel values is below a predetermined threshold. This is not obvious, because it is assumed that a small difference between pixel values means no or hardly any movement and hence much filtering should be applied. Or in other words, the value of the new output pixels is primarily determined by the value of the previous output pixel and hardly on the input pixel. However according to the invention the amount of filtering should be low in the case of a difference between the value of the output pixel and the value of the input pixel, which is below a predetermined threshold. By applying less filtering, the influence of values of the input pixels on the values of the output pixels increases and hence the values of the output pixels converge to the required value.

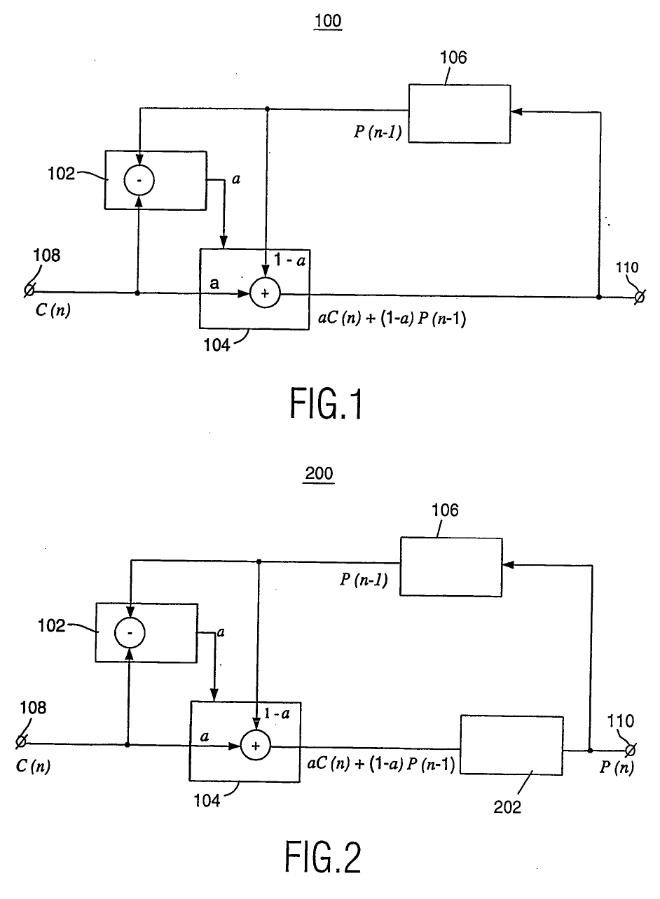

In an embodiment of the temporal recursive filter unit according to the invention, the predetermined threshold depends on calculation accuracy of the temporal recursive filter unit. Typically filter units are implemented by means of fixed point arithmetic. Above it is described that truncation is required to convert pixels represented by N number of bits to M number of bits. Before truncation, an offset is added. Typically this offset is equal to 0.5 times the value of the least significant bit in the representation with M bits. The predetermined threshold is related to the size of the offset being used. In other words the predetermined threshold is related to the number of bits being used to represent the images. See FIG. 1 and FIG. 2 for examples.

An embodiment of the temporal recursive filter unit according to the invention comprises an error diffusion unit for diffusing truncation errors which are made by conversion of an intermediate image into the second output image. Error diffusion is another approach to deal with the “long term dirty window effect”. By applying the invention in a temporal recursive filter unit with an error diffusion unit, the convergence to the required output value is improved.

An embodiment of the temporal recursive filter unit according to the invention comprises a motion compensation unit for matching the first pixel with the second pixel. It is advantageous to apply motion estimation in combination with motion compensation in the temporal recursive filter unit according to the invention. By means of that corresponding pixels of successive images can be mixed.

Modifications of the temporal recursive filter unit and variations thereof may correspond to modifications and variations thereof of the method described and of the image processing apparatus described.

These and other aspects of the temporal recursive filter unit, of the method and of the image processing apparatus according to the invention will become apparent from and will be elucidated with respect to the implementations and embodiments described hereinafter and with reference to the accompanying drawings, wherein:

FIG. 1 schematically shows an embodiment of the temporal recursive filter unit according to the invention;

FIG. 2 schematically shows an embodiment of the temporal recursive filter unit comprising an error diffusion unit;

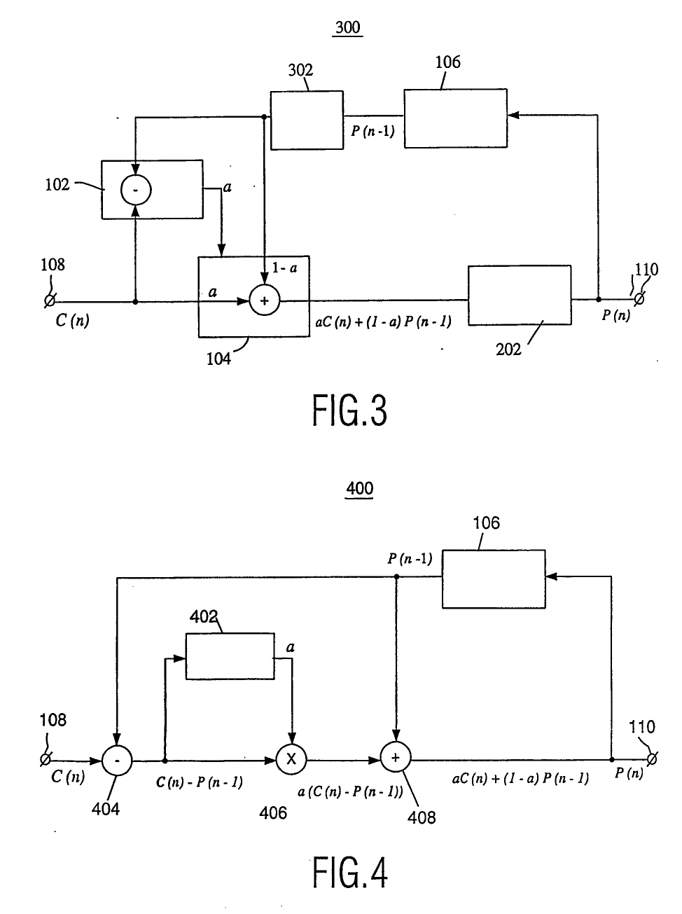

FIG. 3 schematically shows an embodiment of the temporal recursive filter unit comprising a motion compensation unit;

FIG. 4 schematically shows an alternative implementation of an embodiment of the temporal recursive filter unit;

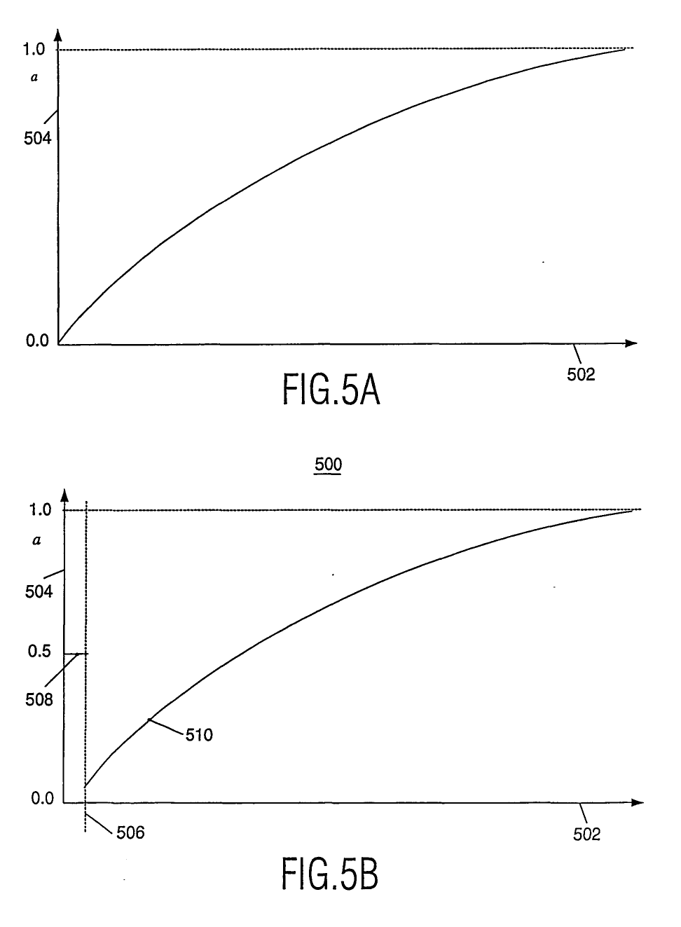

FIG. 5A schematically shows the value of the weighing factor as function of the difference between pixels according to the prior art;

FIG. 5B schematically shows the value of the weighing factor as function of the difference between pixels according to the invention; and

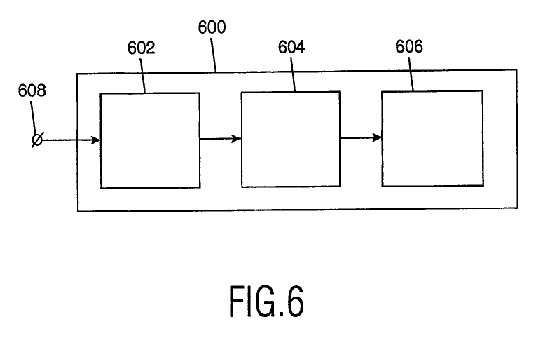

FIG. 6 schematically shows an embodiment of the image processing apparatus according to the invention.

Corresponding reference numerals have the same meaning in all of the Figs.

FIG. 1 schematically shows an embodiment of the temporal recursive filter unit 100 according to the invention. The temporal recursive filter unit 100 comprises:
means 102 for determining a value of a weighing factor α(x, n) for a first value C(x, n) of a first pixel of an input image of a series of input images and a second value P(x, n−1) of a second pixel of a first output image of a series of output images, on basis of a difference between the first value and the second value;
an adding unit 104 for calculating a third value P(x, n) of a third pixel of a second output image of the series of output images by adding of a first product of the value of the weighing factor α(x, i) and the first value C(x, n) of the first pixel, to a second product of a complement 1−α(x, n) of the value of the weighing factor α(x, n) and the second value P(x, n−1) of the second pixel; and
a memory unit 106 for storage of the first output image. This is a required for introducing a delay.

The index n denotes an image number and the vector x corresponds to the coordinates of a pixel. At the input connector 108 the series of input images is provided. The temporal recursive filter unit 100 provides the series of output images at its output connector 110. The means 102 for determining the value of the weighing factor α(x,n) is arranged to determine the value based on comparing pixel values of input and output images. This can be by taking into account the luminance values of only two pixels, i.e. one pixel from the current input image and one pixel from the previously filtered output image. However preferably several pixels in the neighborhood of the pixels are taken into account. In U.S. Pat. No. 6,115,502 an example of the calculation of the weighing factor k is specified. This can be rewritten to Equation 1:

$$α ( \underline{x} , \underline{n} ) = LUT ( {\sum }_{{n}_{2} = {N}_{2}} ( abs {\sum }_{{n}_{1} = {N}_{1}} C ( \underline{x} + {\underline{n}}_{1} + {\underline{n}}_{2} , n ) - P ( \underline{x} + {\underline{n}}_{1} + {\underline{n}}_{2} , n - 1 ) ) ) \qquad ( 1 )$$

with C(x, n) the value of the input pixel at position x for image n and P(x, n−1) the value of the output pixel at position x for image n−1 and where N_{1 and N}₂ are neighborhoods around the current pixel. LUT means a look-up-table function.

The transfer function of the temporal recursive filter unit 100 can be described with Equation 2:
P(x,n)=α(x,n)C(x,n)+(1−α(x,n))P(x,n−1) (2)

By means of an example it will be explained how the temporal recursive filter unit according to the invention works. The example shows how the value P(x,n) of an output pixel of a recursive filter changes when the value of the input pixel C(x,n) changes from C(x,0)=100 to C(x,1)=10. The example comprises 3 parts:
In Table 1 it will be demonstrated that the value of the output pixel P(x,n) converges to the required value, in the case of a filter unit which is not restricted by a limited word size. That means that no truncation is applied.
In Table 2 it will be demonstrated that the value of the output pixel P(x,n) does not converge to the required value, in the case of a filter unit in which truncation is applied.

In Table 3 it will be demonstrated that the value of the output pixel P(x,n) converges to the required value, in the case of a filter unit in which truncation is applied and in which the invention is applied: an embodiment of a temporal recursive filter unit according to the invention.

TABLE 1
Step response in a filter unit with maximum accuracy

| n | C(x, n) | α(x, n) | P(x, n) |
|---|---|---|---|
| −1 | | | 100 |
| 0 | 100 | 1 | 100 |
| 1 | 10 | 14 | 21.25 |
| 2 | 10 | 1 | 20.54688 |
| 3 | 10 | 1 | 19.8877 |
| 4 | 10 | 1 | 19.26971 |
| 5 | 10 | 1 | 18.69036 |
| 6 | 10 | 1 | 18.14721 |
| 7 | 10 | 1 | 17.63801 |
| 8 | 10 | 1 | 17.16063 |
| . | . | . | . |
| . | . | . | . |
| . | . | . | . |
| 93 | 10 | 1 | 10.02968 |
| 94 | 10 | 1 | 10.02783 |
| 95 | 10 | 1 | 10.02609 |
| 96 | 10 | 1 | 10.02446 |

The values of P(x,n) in Table 1 are calculated by means of Equation 3:
P(x,n)=(α(x,n)C(x,n)+(16−α(x,n))P(x,n−1))/16 (3)

The value of the weighing factor α(x,n) ranges from [1,16] and is set to 14 for n=1 and is set to 1 for n=0, 2, 3, 4, . . . . The value of the weighing factor α(x,n) depends on the difference between P(x,n−1) and C(x,n). In Table 1 it can be seen that the value of P(x,n) converges very slowly to the required value 10: for n=96 the value of P(x,n)=10.02446.

TABLE 2
Step response in a filter unit according to the prior art.

| n | C(x, n) | α(x, n) | P(x, n) |
|---|---|---|---|
| −1 | | | 100 |
| 0 | 100 | 1 | 100 |
| 1 | 10 | 14 | 21 |
| 2 | 10 | 1 | 20 |
| 3 | 10 | 1 | 19 |
| 4 | 10 | 1 | 18 |
| 5 | 10 | 1 | 18 |
| 6 | 10 | 1 | 18 |
| 7 | 10 | 1 | 18 |
| 8 | 10 | 1 | 18 |
| 9 | 10 | 1 | 18 |

The values of P(x,n) in Table 2 are calculated by means of Equation 4:
P(x,n)=truncate((α(x,n)C(x,n)+(16−α(x,n))P(x,n−1)+8)/16) (4)

This corresponds with a fixed point representation where the input and output data is represented with 8 bits. Before truncation an offset of 8/16 is added. In Table 2 it can be seen that the required value 10 is not reached. Because of the truncation the value of P(x,n) does not become lower than 18.

TABLE 3
Step response in a filter unit according to the invention

| n | C(x, n) | α(x, n) | P(x, n) |
|---|---|---|---|
| −1 | | | 100 |
| 0 | 100 | 9 | 100 |
| 1 | 10 | 14 | 21 |
| 2 | 10 | 1 | 20 |
| 3 | 10 | 1 | 19 |
| 4 | 10 | 1 | 18 |
| 5 | 10 | 9 | 14 |
| 6 | 10 | 9 | 12 |
| 7 | 10 | 9 | 11 |
| 8 | 10 | 9 | 10 |
| 9 | 10 | 9 | 10 |

The values of P(x,n) in Table 3 are calculated by means of Equation 4. The difference with Table 2 is that now the value of the weighing factor α(x,n) is set to 9 for n=0, 5, 6, 7, . . . . The value of the weighing factor α(x,n) depends on the difference between P(x,n−1) and C(x,n). In Table 3 it can be seen that the required value 10 is reached. This is because the value of the weighing factor α(x,n) is set to a high value for small differences between P(x,n−1) and C(x,n).

FIG. 2 schematically shows an embodiment of the temporal recursive filter unit 200 comprising an error diffusion unit 202. In stead of a fixed rounding by means of adding a constant offset of 0.5 the error diffusion unit 202 of this temporal recursive filter unit 200 according to the invention preserves the truncation error made for a pixel and uses this as a variable “offset” for a succeeding pixel. Note that a spatial error diffusion can be applied. A standard truncation works as specified in Equation 5:
Output(i)=truncate(Input(i)+0.5) (5)
with index i. The error diffusion unit 202 works as specified in Equation 6:
Output(i)=truncate(Input(i)+rest) (6)
with,
rest=Input(i−1)−truncate(Input(i−1) (7)
Substitution of Equation 7 into Equation 6 yields:
Output(i)=truncate((Input(i)+(Input(i−1)−truncate(Input(i−1)) (8)

Table 4 gives an example of a standard truncation with a fixed offset of 0.5 according to Equation 5 and Table 5 gives an example of a truncation based on error diffusion according to Equation 8.

TABLE 4
Standard truncation

| i | Input(i) | Offset | Output(i) |
|---|---|---|---|
| 1 | 20.3 | 0.5 | 20 |
| 2 | 19.6 | 0.5 | 20 |
| 3 | 17.4 | 0.5 | 17 |
| 4 | 16.7 | 0.5 | 17 |

TABLE 5
Truncation based on error diffusion

| i | Input(i) | rest | Output(i) |
|---|---|---|---|
| 0 | | 0.4 | |
| 1 | 20.3 | 0.3 | 20 |
| 2 | 19.6 | 0.6 | 19 |
| 3 | 17.4 | 0.4 | 18 |
| 4 | 16.7 | 0.7 | 17 |

By means of an example it will be explained how the temporal recursive filter unit 200 according to the invention works. The example shows how the value P(x,n) of an output pixel of a recursive filter changes when the value of the input pixel C(x,n) changes from C(x,0)=100 to C(x,1)=10. The example comprises 2 parts:
In Table 6 it will be demonstrated that the value of the output pixel P(x,n) converges to the required value very slowly in the case of a filter unit according to the prior art in which error diffusion is applied.

In Table 6 it will be demonstrated that the value of the output pixel P(x,n) converges much faster to the required value, in the case of a filter unit according to the invention in which error diffusion is applied.

TABLE 6
Step response in a filter unit according to the prior
art with an error diffusion unit

| n | C(x, n) | α(x, n) | rest | P(x, n) |
|---|---|---|---|---|
| −1 | | | | 100 |
| 0 | 100 | 1 | 14 | 100 |
| 1 | 10 | 14 | 1 | 21 |
| 2 | 10 | 1 | 8 | 20 |
| 3 | 10 | 1 | 12 | 20 |
| 4 | 10 | 1 | 7 | 19 |
| 5 | 10 | 1 | 12 | 19 |
| 6 | 10 | 1 | 3 | 18 |
| 7 | 10 | 1 | 10 | 18 |
| 8 | 10 | 1 | 2 | 17 |
| 9 | 10 | 1 | 5 | 16 |
| 10 | 10 | 1 | 9 | 16 |
| 11 | 10 | 1 | 13 | 16 |
| 12 | 10 | 1 | 4 | 15 |
| 13 | 10 | 1 | 15 | 15 |
| 14 | 10 | 1 | 4 | 14 |
| 15 | 10 | 1 | 8 | 14 |
| 16 | 10 | 1 | 15 | 14 |
| 17 | 10 | 1 | 1 | 13 |

The values of P(x,n) in Table 6 are calculated by means of Equation 9:
P(x,n)=truncate((α(x,n)C(x,n)+(16−α(x,n))P(x,n−1)+rest)/16) (9)

with rest ranging from [0,15] and being calculated as specified in Equation 7. The value of the weighing factor α(x,n) ranges from [1,16] and is set to 14 for n=1 and is set to 1 for n=0, 2, 3, 4, . . . . The value of the weighing factor α(x,n) depends on the difference between P(x,n−1) and C(x,n). The output pixel P(x,n) converges to the required value very slowly.

TABLE 7
Step response in a filter unit according to the invention
with an error diffusion unit

| n | C(x, n) | α(x, n) | rest | P(x, n) |
|---|---|---|---|---|
| −1 | | | | 100 |
| 0 | 100 | 8 | 14 | 100 |
| 1 | 10 | 14 | 1 | 21 |
| 2 | 10 | 1 | 8 | 20 |
| 3 | 10 | 1 | 12 | 20 |
| 4 | 10 | 1 | 7 | 19 |
| 5 | 10 | 1 | 12 | 19 |
| 6 | 10 | 1 | 3 | 18 |
| 7 | 10 | 8 | 10 | 14 |
| 8 | 10 | 8 | 2 | 12 |
| 9 | 10 | 8 | 5 | 11 |
| 10 | 10 | 8 | 9 | 11 |
| 11 | 10 | 8 | 13 | 11 |
| 12 | 10 | 8 | 4 | 10 |
| 13 | 10 | 8 | 15 | 10 |

The values of P(x,n) in Table 7 are calculated by means of Equation 9, with rest ranging from [0,15] and being calculated as specified in Equation 7. The value of the weighing factor α(x,n) ranges from [1,16] and is set to 14 for n=1 and is set to 1 for n=2, 3, . . . , 6 and set to 8 for n=0, 7, 8, 9, . . . . The value of the weighing factor α(x,n) depends on the difference between P(x,n−1) and C(x,n). The output pixel P(x,n) converges to the required value much faster.

FIG. 3 schematically shows an embodiment of the temporal recursive filter unit 300 comprising a motion compensation unit 302. Because of motion in the scene being captured, pixels from successive images with mutually equal coordinates will not correspond to the same portions of objects in the scene. In order to match corresponding pixels motion estimation is required resulting in a motion vector field comprising an arrangement of motion vectors. The motion compensation unit 302 is arranged to match corresponding pixels based on the estimated motion vectors.

FIG. 4 schematically shows an alternative implementation of an embodiment of the temporal recursive filter unit 400 according to the invention. The behavior of the temporal recursive filter unit 400 corresponds with the temporal recursive filter unit 100 described in connection with FIG. 1. The advantage of this implementation is that only one multiplication unit 406 is required. But note that the arrangement of the subtraction unit 404, the multiplication unit 406 and the addition unit 408 results in an addition of a first product of the value of the weighing factor α(x,n) and the first value C(x,n) of the first pixel, to a second product of a complement 1−α(x,n) of the value of the weighing factor α(x,n) and the second value P(x,n−1) of the second pixel.

The size of the memory unit 106 for storage of an output image, in any of the temporal recursive filter units 100, 200, 300 or 400, might be such that an output image can be stored with the same number of bits per pixel as being used to represent the output image provided at the output connector 110. Optionally embedded compression is applied to reduce the size of the memory unit. This is not shown in any of the FIGS. 1-4. Especially in the case of lossy compression it is advantageous to apply the invention.

FIG. 5A schematically shows the value of the weighing factor α as function of the difference between pixels according to the prior art. The x-axis 502 corresponds to a measure based on the difference between the value of a pixel of the input image and the value of a pixel of the output image. The y-axis 504 corresponds to the weighing factor α. The function is monotonously increasing. In other prior art, e.g. U.S. Pat. No. 5,119,195 also curves showing the value of variable k as function of motion are provided. These curves have a similar shape: not-decreasing. The higher the motion, i.e. the difference between input and output images, the higher the value of the variable k.

FIG. 5B schematically shows the value of the weighing factor α as function of the difference between pixels according to the invention. The x-axis 502 corresponds to a measure based on the difference between the value of a pixel of the input image and the value of a pixel of the output image. The y-axis 504 corresponds to the weighing factor α. Two sub-curves are depicted: one below the predetermined threshold 506 and one above the predetermined threshold 506. Below the predetermined threshold 506 the value of the weighing factor α is relatively high compared with values belonging to the sub-curve above the predetermined threshold. Above the predetermined threshold 506 the value of the weighing factor α increases for larger differences between the values of the pixels. Hence, a first value 508 corresponding to a difference being lower than the predetermined threshold is higher than a second value 510 corresponding to a difference being higher than the predetermined threshold.

The value of the weighing factor α below the predetermined threshold is equal to 0.5. This is just an example value. Besides that it is possible that there are multiple values below the predetermined threshold, e.g. a function of the weighing factor α with a staircase shape.

FIG. 6 schematically shows an embodiment of the image processing apparatus 600 according to the invention, comprising:
receiving means 602 for receiving a series of input images. The received signal may be a broadcast signal received via an antenna or cable but may also be a signal from a storage device like a VCR (Video Cassette Recorder) or Digital Versatile Disk (DVD). The signal is provided at the input connector 608.
a temporal recursive filter unit 604 for noise filtering of the series of input images resulting in a series of output images as described in connection with any of the FIGS. 1-4.
display means 606 for displaying the series of output images. The image processing apparatus 600 might be a TV.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A temporal recursive filter unit (100,200,300,400) for noise filtering of a series of input images resulting in a series of output images, comprising
means (102) for determining a value (508) of a weighing factor, on basis of a difference between a first value of a first pixel of an input image of the series of input images and a second value of a second pixel of a first output image of the series of output images; and
an adding (104) unit for calculating a third value of a third pixel of a second output image of the series of output images by adding a first product of the value of the weighing factor and the first value of the first pixel, and a second product of a complement of the value of the weighing factor and the second value of the second pixel, characterized in that the means (102) for determining the value (508) of the weighing factor is arranged to provide the value (508) of the weighing factor, which is higher than a further value (510) of the weighing factor if the difference between the first value and the second value is below a predetermined threshold, with the further value belonging to a further difference of further values of further pixels, with the further difference being above the predetermined threshold.

2. A temporal recursive filter unit (100,200,300,400) as claimed in claim 1, characterized in that the predetermined threshold depends on calculation accuracy of the temporal recursive filter unit (100,200,300,400).

3. A temporal recursive filter unit (200,300) as claimed in claim 1, characterized in comprising an error diffusion unit for diffusing truncation errors which are made by conversion of an intermediate image into the second output image.

4. A temporal recursive filter unit (300) as claimed in claim 1, characterized in comprising a motion compensation unit for matching the first pixel with the second pixel.

5. A method of noise filtering of a series of input images resulting in a series of output images, comprising
a weighing factor determination step of determining a value of a weighing factor, on basis of a difference between a first value of a first pixel of an input image of the series of input images and a second value of a second pixel of a first output image of the series of output images; and
an adding step of calculating a third value of a third pixel of a second output image of the series of output images by adding of a first product of the value of the weighing factor and the first value of the first pixel, to a second product of a complement of the value of the weighing factor and the second value of the second pixel, characterized in that in the weighing factor determination step the value (508) of the weighing factor is determined, which is higher than a further value (510) of the weighing factor if the difference between the first value and the second value is below a predetermined threshold, with the further value belonging to a further difference of further values of further pixels, with the further difference being above the predetermined threshold.

6. An image processing apparatus (600) comprising:
receiving means (602) for receiving a series of input images;
a temporal recursive filter unit (100,200,300,400) for noise filtering of the series of input images resulting in a series of output images, comprising
means (102) for determining a value of a weighing, on basis of a difference between a first value of a first pixel of an input image of the series of input images and a second value of a second pixel of a first output image of the series of output images; and
an adding unit (104) for calculating a third value of a third pixel of a second output image of the series of output images by adding of a first product of the value of the weighing factor and the first value of the first pixel, to a second product of a complement of the value of the weighing factor and the second value of the second pixel.
Characterized in that the means (102) for determining the value (508) of the weighing factor is arranged to provide the value (508) of the weighing factor, which is higher than a further value (510) of the weighing factor if the difference between the first value and the second value is below a predetermined threshold, with the further value belonging to a further difference of further values of further pixels, with the further difference being above the predetermined threshold.

7. An image processing apparatus (600) as claimed in claim 6, characterized in further comprising display means (606) for displaying the series of output images.

8. An image processing apparatus as claimed in claim 7, characterized in that it is a TV.
